(19) United States
(12) Patent Application Publication
(10) Pub. No.: US 2016/0102228 A1
(43) Pub. Date: Apr. 14, 2016

(54) ADHESIVE COMPOSITIONS AND THE USE THEREOF

(71) Applicant: HENKEL IP & HOLDING GMBH, Duesseldorf (DE)

(72) Inventors: Jennifer THATCHER, Chesterfield, NJ (US); Yuhong HU, Belle Mead, NJ (US)

(21) Appl. No.: 14/972,971

(22) Filed: Dec. 17, 2015

Related U.S. Application Data
(63) Continuation of application No. PCT/US2014/043389, filed on Jun. 20, 2014.
(60) Provisional application No. 61/837,769, filed on Jun. 21, 2013.

(51) Int. Cl. C09J 7/02

(52) U.S. Cl. CPC C09J 7/021; C08K 5/01

(57) ABSTRACT

The present invention relates to pressure sensitive hot melt adhesive compositions that comprise greater than about 15 wt % of a metallocene-catalyzed polyolefin random copolymer. The pressure sensitive hot melt adhesive has a heat of fusion less than 1.5 J/g and a peak glass transition temperature from −40° C. to 5° C. Crystallization in the adhesive is inhibited over time, and thus, the adhesive maintains a balance of peel and tack performances, making the adhesive particularly well suited for electronics, medical, industrial, graphics, construction and consumer goods applications.

### FIELD OF THE INVENTION

The present invention relates to pressure sensitive hot melt adhesive compositions that comprise a metallocene-catalyzed polyolefin random copolymer. Crystallization in the adhesives are inhibited over time and the adhesives maintain a balance of peel and tack performances, making these adhesives particularly well suited for electronics, medical, industrial, graphics, construction and consumer goods applications.

### BACKGROUND OF THE INVENTION

Pressure sensitive adhesive is aggressive, permanent tacky, adheres to a substrate with finger or hand pressure, and exerts a strong holding force to the substrate. The pressure sensitive adhesives do not require any solvent, water, or heat to activate the adhesives. Pressure sensitive adhesives form bonds by balancing flow and resistance to flow: the adhesives are soft enough to flow and wet the substrate, and the bond has strength because the adhesives are hard enough to resist flow when stress is applied to the bond.

Pressure sensitive hot melt adhesives are applied to a substrate while in a molten state and cooled to harden the pressure sensitive adhesive layer. Such adhesives are widely used for various commercial and industrial applications such as film, label, packing slip, pouch, security bag, tape, graphic art, positioning adhesive, medical dressing, personal care product, hygienic applications, feminine care product, and the like.

Typical pressure sensitive hot melt adhesive (PSHMA) is formed from an elastomeric base polymer. Widely selected elastomeric base materials include natural rubber, vinyl ethers, acrylics, butyl rubber, styrene block copolymers, silicones and nitriles. Rubber-based PSHMA adheres well to various substrates, but tends to yellow over time and is not recommended for high heat application. PSHMA formed with acrylic polymers generally has a better long term aging performances, but has poor adhesion to low-surface energy substrates. Silicone-based PSHMA also suffers from poor adhesion to low surface energy substrates.

While the recent development of polymers technology has increased the number of base polymers for PSHMA, not all of them can meet the performance requirement of peel and tack of PSHMA. Typical polyolefins have high percent of crystallinity in the structure, and thus, adhesive made with such polyolefins do not meet the performance requirements of pressure sensitive adhesives. Also, the use of amorphous poly-alpha-olefins in PSHMA results in cohesive failures, and the amorphous poly-alpha-olefins in the adhesive tend to build crystallinity over time, thereby losing tack. In fact, Pressure-Sensitive Adhesive and Applications, 2^{nd} Ed., Istvan Benedek, CRC Press, 2004, pp 144-145, teaches that adhesives made with amorphous poly-alpha-olefins exhibit initial pressure sensitive adhesive properties due to long open time; however, afterwards the adhesives are no longer tacky. U.S. Pat. No. 7,199,180 teaches that pressure sensitive adhesives can be formed with low molecular weight (weight average molecular weight, Mw, of less than 100,000) metallocene catalyzed ethylene/alpha-olefin polymers; however, it is silent as to the adhesives' ability to maintain pressure sensitivity over a prolonged time.

Another widely known class of elastomeric base polymer is an olefin block copolymer (OBC), produce by chain shuttling technology. The OBCs have alternating blocks of semi-crystalline and elastomeric segment structure, similar to those of styrene block copolymers; however, OBC-based PSHMA lose tack and have poor wet-out performance over time due to the OBC's high crystallinity.

There is a need in the art for a PSHMA that possesses a balance of peel and tack performances for an extended period of time. The current invention fulfills this need.

### BRIEF SUMMARY OF THE INVENTION

The invention provides polyolefin based pressure sensitive hot melt adhesives. The present invention provides polyolefin based pressure sensitive hot melt adhesives and articles of manufacture comprising the polyolefin based pressure sensitive hot melt adhesives.

One aspect of the invention is directed to pressure sensitive hot melt adhesives comprising greater than about 15 weight percent of a metallocene-catalyzed polyolefin random copolymer. The adhesives have (i) a heat of fusion less than 1.5 J/g, measured at 1° C./min heating and cooling rate in accordance with ASTM D3418-12, and (ii) a glass transition temperature (Tg) from −40° C. to 5° C.

Another aspect of the invention is directed to a hot melt pressure sensitive adhesives comprising (a) about 10 to about 40 wt % of a metallocene-catalyzed polyolefin random copolymer that has a heat of fusion less than about 15 J/g measured at 10° C./min heating and cooling rate in accordance with ASTM D3418-12; (b) about 40 to about 85 wt % of a tackifier; (c) about 1 to about 50 wt % of a plasticizer; and (d) optionally, an additive. The pressure sensitive adhesives have (i) a heat of fusion less than 1.5 J/g, measured at 1° C./min heating and cooling rate in accordance with ASTM D3418-12; (ii) a glass transition temperature (Tg) from −40° C. to 5° C.; and (iii) a storage modulus (G′), at 25° C., of less than 5×10⁴ Pascal.

Yet another aspect of the inventions directed hot melt pressure sensitive adhesives comprising greater than 15 wt % of a polyolefin polymer; wherein the adhesives have (i) a heat of fusion less than 1.5 J/g measured at 1° C./min heating and cooling rate in accordance with ASTM D3418-12; (ii) a glass transition temperature (Tg) from −40° C. to 5° C.; (iii) a peel force of at least 150 gf/in on a cotton fabric substrate in accordance with cotton peel method at 25 gsm add-on level; and (iv) an aged peel force after 10 weeks at 40° C. of at least 100 gf/in on a cotton fabric substrate in accordance with cotton peel method at 25 gsm add-on level.

### DETAILED DESCRIPTION OF THE INVENTION

As used herein, “pressure sensitive adhesive” (herein PSA) and “pressure sensitive hot melt adhesive” (herein PSHMA) are adhesive compositions that have the ability at, or at about, room temperature (about 25° C.) to sufficiently wet a substrate under gentle pressure and to form a useful bond. As used here, the term “useful bond” differs depending on the substrate application and refers to a corresponding balance of adhesive and cohesive strength.

All weight percents, wt %, expressed herein are based on the total weight of the adhesive composition, which adds to 100 wt %.

The term polymer as used above includes homopolymers and copolymers such as terpolymers, tetrapolymers, and etc.

The PSHMA of the invention comprises a polyolefin random copolymer, which has a heat of fusion less than 15 J/g, measured at 10° C./min heating and cooling rate in accordance with ASTM D3418-12. The PSHMA comprise greater than about 15wt % of the polyolefin random copolymer.

The polyolefin random copolymer is a metallocene-catalyzed polyolefin random copolymer. This copolymer is randomly ordered, without any specific order to the polymer structure. The copolymer is described as having semi-crystalline structure, and specifically contains low crystallinity in the copolymer.

The term “semi-crystalline” used for the olefinic polymer refers to those polymeric materials that contain both crystalline and amorphous regions in the solid state. In the crystalline region, the molecular chains of the polymers are all arranged in ordered three-dimensional arrays whose structure can be fully characterized by their unit cells, the smallest structural unit used to describe a crystal. The amorphous polymers, in contrast, do not have ordered three-dimensional structures in the solid state. Their molecular chains are arranged in a completely random fashion in space. Semi-crystalline polymers can be easily distinguished from completely amorphous polymers by observing the presence or absence of a melting point (Tm) and the associated enthalpy or heat of fusion (AHD derived from the transformation of the crystalline state to molten state upon heating. All semi-crystalline polymers exhibit a melting point, whereas the melting point is absent for amorphous polymers. Amorphous polymers undergo a transition from a glassy solid to a rubbery elastic state in a narrow temperature range around a glass transition temperature Tg. One should not confuse the glass transition temperature Tg with the melting point Tm.

The melting point Tm, the enthalpy or fusion (ΔHf) can be determined by Differential Scanning calorimetry (DSC). The technique is well known to those skilled in the art and is well described in scientific literature. The metallocene-catalyzed polyolefin random copolymer has a heat of fusion value of less than 30 J/g, more preferably less than 20 J/g, and most preferably less than 15 J/g, measured at 10° C./min heating and cooling rate in accordance with ASTM D3418-2.

It should be pointed out that semi-crystalline polymers defined above are often referred to as crystalline polymers in the trade. Except for the single crystals prepared in the laboratories on a small scale, perfect crystalline polymers are not encountered in the commercial world and all so-called crystalline polymers, strictly speaking, are semi-crystalline. The definition of semi-crystalline polymers set forth herein, therefore, embraces the term “crystalline polymers”.

In addition, the weight average molecular weight (Mw) of the polyolefin random copolymer is greater than 100,000, preferably greater than 100,100, more preferably greater than 100,500, and most preferably, greater than 101,000 Daltons. The use of polyolefin random copolymers with Mw less than 100,000 is not preferred because adhesives made from such copolymers have low cohesive strength and thus, result in low shear strength.

The metallocene-catalyzed polyolefin random copolymers of the type described above can be purchased from numerous commercial sources, such as Exxon Mobil Chemical under the trade name Vistamaxx.

In one embodiment, the PSHMA further comprises another polymer, in an amount less than 10 wt %.

In another embodiment, the PSHMA is essentially free of other polymers that have a heat of fusion less than 15J/g.

Yet in another embodiment, the PSHMA is essentially free of any other polymers other than the metallocene-catalyzed polyolefin random copolymers with a ΔHf below 15J/g. The addition of other polymers, e.g., styrene block polymers, olefin block copolymer (chain shuttling technology), and amorphous poly-alpha-olefin polymer, lead to undesirable adhesive performance, such as decreased tack and peel performances in the PSA, increased viscosity, incompatibility with the metallocene-catalyzed polyolefin random copolymer and/or poor heat resistance.

The PSHMA further comprises a tackifier. As used herein, the term “tackifier” refers to one or more compounds that are useful to impart tack to the adhesive of the present invention. Examples of suitable tackifiers, include, but are not limited to, aliphatic hydrocarbon resins, aromatic modified aliphatic hydrocarbon resins, hydrogenated polycyclopentadiene resins, polycyclopentadiene resins, gum rosins, gum rosin esters, wood rosins, wood rosin esters, tall oil rosins, tall oil rosin esters, polyterpenes, aromatic modified polyterpenes, terpene phenolics, aromatic modified hydrogenated polycyclopentadiene resins, hydrogenated aliphatic resin, hydrogenated aliphatic aromatic resins, hydrogenated terpenes and modified terpenes, hydrogenated rosin acids, and hydrogenated rosin esters. In some embodiments the tackifier is hydrogenated.

In other embodiments, the tackifier is non-polar, which indicates that the tackifier is substantially free of monomers having polar groups. Preferably the polar groups are not present, however if they are preferably they are not present at more that 15 wt %, preferably not more that 10 wt %, even more preferably no more than 5 wt %. In some embodiments the tackifier has a softening point (Ring and Ball, as measured by ASTM E-28) of 80° C. to 150° C., preferably 100° C. to 130° C. In another embodiment the resin is a liquid and has a Ring and Ball softening point of between 10 and 80° C.

Preferred hydrocarbon resins for use as tackifiers or modifiers include:
1. Resins such as C5/C6 terpene resins, styrene terpenes, alpha-methyl styrene terpene resins, C9 terpene resins, aromatic modified C5/C6, aromatic modified cyclic resins, aromatic modified dicyclopentadiene based resins or mixtures thereof. Typically these resins are obtained from the cationic polymerization of compositions containing one or more of the following monomers: C5 diolefins (such as 1-3 pentadiene, isoprene, etc); C5 olefins (such as 2-methylbutenes, cyclopentene, etc.); C6 olefins (such as hexene), C9 vinylaromatics (such as styrene, alpha methyl styrene, vinyltoluene, indene, methyl indene, etc.); cyclics (such as dicyclopentadiene, methyldicyclopentadiene, etc.); and or terpenes (such as limonene, carene, etc).
2. Resins obtained by the thermal polymerization of dicyclopentadiene, and/or the thermal polymerization of dimers or oligomers of cyclopentadiene and/or methylcyclopentadiene, optionally with vinylaromatics (such as styrene, alpha-methyl styrene, vinyl toluene, indene, methyl indene).

The resins obtained after polymerization and separation of unreacted materials can be hydrogenated if desired.

The tackifier is typically present at about 40 to about 85 wt %, based upon the total weight of the adhesive, and more preferably at about 45 to about 80 wt %.

Preferred plasticizers include oils, polybutenes, phthalates benzoates, adipic esters and the like. Suitable oils include mineral oil, aliphatic oils, aromatic oils, olefin oligomers and low molecular weight polymers, as well as vegetable and animal oils and derivatives of such oils. The petroleum derived oils which may be employed are relatively high boiling materials containing only a minor proportion of aromatic hydrocarbons. In this regard, the aromatic hydrocarbons should preferably be less than 30% and more particularly less than 15% of the oil, as measured by the fraction of aromatic carbon atoms. The oligmers may be polypropylenes, polybutenes, hydrogenated polyisoprenes, hydrogenated polybutadiens, or the like having average molecular weight between about 350 and about 10,000. Suitable vegetable and animal oils include glycerol esters of the usual fatty acids and polymerization products thereof. Particularly preferred oils include aliphatic naphthenic oils.

Plasticizer is typically present at about 1 to about 50 wt %, based upon the total weight of the adhesive, more preferably 10 to 40 wt %.

Surprisingly, the combination of the metallocene-catalyzed polyolefin random copolymer that has a ΔHf less than 15 J/g, tackifier and plasticizer inhibits the crystallization in the adhesive to maintain pressure sensitivity of the adhesive. Peel and tack performances of the PSHMA of the invention is balanced even after the adhesive is aged for 10, and even up to 16 weeks.

The PSHMA optionally comprises additives known in the art such as stabilizers, antioxidants, fillers, additives, pigments, dyestuffs, polymeric additives, defoamers, preservatives, thickeners, rheology modifiers, humectants, masterbatches, waxes, nucleating agent, block, antiblock, processing aids, UV stabilizers, neutralizers, lubricants, surfactants and adhesion promoters.

Preferred antioxidants include thioesters, phosphates, hindered phenols, tetrakis (methylene 3-(3′,5′-di-t-butyl-4 hydroxyphenyl)pro-pionate)methane, 2,2′-ethyldenebis (4,6-di-tertiarybutylphenol), 1,1-3-tris(2-methyl-4-hydroxy-5-t-butylephenyl) butane, 1,3,5-trimethyl2,4,6,tris(3,5-tertbutyl-4-hydroxybenzyl)benzene, dilaurylthiodipropionate, pentaerythritol tetrakis(beta-laurylthiopropionate), alkyl-aryldi-and polyphosphates, thiophosphites, and combinations or derivatives thereof.

Preferred fillers include titanium dioxide, calcium carbonate, barium sulfate, silica, silicon dioxide, carbon black, sand, glass beads, mineral aggregates, talc, clay, calcium sulfate, calcium metasilicate, aluminium silicates, china clay, kaolin, glimmer, Mg- and Al-oxides and hydroxides glass fibers, synthetic fibers.

Preferred additives include silicon dioxide, titanium dioxide, polydimethylsiloxane, talc, dyes, calcium sterate, carbon black, low molecular weight resins and glass beads. Preferred adhesion promoters include polar acids, polyaminoamides (such as Versamid 115, 125, 140, available from Henkel), urethanes (such as isocyanate/hydroxy terminated polyester systems, e.g. bonding agent TN/Mondur Cb-75 (Miles, Inc.), coupling agents, (such as silane esters (Z-6020 from Dow Corning)), titanate esters (such as Kr-44 available from Kenrich), reactive acrylate monomers (such as sarbox SB-600 from Sartomer), metal acid salts (such as Saret 633 from Sartomer), polyphenylene oxide, oxidized polyolefins, acid modified polyolefins, and anhydride modified polyolefins.

The adhesive composition is prepared by standard melt blending procedures. Any mixing method producing a homogeneous blend without degrading the components is satisfactory. In particular, the mixing temperatures depend upon the particular adhesive formulation, and are generally in the range of about 130° C. to about 200° C., with about 135° C. to about 175° C. being a typical suitable range.

The prepared PSHMA is permanently tacky in dry form and can firmly adhere to a substrate with very light pressure. An adhesive is considered to be a PSA if it is sufficiently soft and meets the Dahlquist criterion by exhibiting an elastic modulus of less than 3×10⁵Pascal (3×10⁶dyn/cm²) on a 1-s time scale at the test temperature. As stress is applied to the PSHMA, adhesive deformation can be described by storage modulus (G′) and loss modulus (G″). Storage modulus is the energy stored by the adhesive is directly related to elasticity. Adhesives with high modulus (higher than the Dahlquist criterion) in the rubbery plateau region are not tacky and do not have PSA properties. The PSHMA of the invention has a storage modulus value of less than 5×10⁴ Pascal at 25° C.

The tan(δ) value is expressed as G″/G′ and this is a function of temperature, and such measurements are well known to those skilled in the art. It is also well understood in the art that the temperature at the peak of tan(δ) is determined to be a representation of the glass transition temperature (Tg) of the adhesive. For a PSA, the peak Tg should be well below the room temperature to allow the adhesive to be tacky and usable at ambient temperatures. The PSHMA of the invention has a peak Tg in the range of −40° C. to 5° C.

The PSHMA of the invention has a heat of fusion less than 1.5 J/g measured at 1° C./min heating and cooling rate in accordance with ASTM D3418-12. Even after aging the PSHMA for a prolong time, the heat of fusion does not significantly change as crystallization in the adhesive is inhibited over time. The PSHMA of the invention maintains a balance of peel and tack performances for a prolonged time under aging conditions.

The adhesive compositions of this invention can be used in any PSA application, including but not limited to films, labels, packing slips, pouches, security bags, tapes, graphic arts, positioning adhesives, medical dressings, personal care products, hygienic applications, feminine care products, and the like. In one embodiment, the PSHMA is applied onto polyethylene and/or polypropylene film as a positioning/garment attachment adhesive for feminine care products. The PSHMA of the invention has affinity to multiple fabric substrates, including microfiber, cotton, nylon, and the like.

The adhesive compositions described above may be applied to a variety of substrate, including substrates with high or low surface energies. The adhesive compositions of the present invention adhere and maintain a balance of peel and tack to both low and high surface energy substrates.

One set of preferred substrates include polyethylene, polypropylene, polyacrylates, acrylics, polyethylene terephthalate, or any of the polymers listed above as suitable for blends and their composites with fillers, glass fibers and the like. Another set of substrates include wood, such as such as particle board, wood-plastic-composites, veneer paper, paper based materials such as melamine impregnated papers, cardboard, plastic, thermoplastic, rubber, metal, metal foil, metallized surfaces, cloth, nonwovens, spunbonded fibers, cardboard, stone, plaster, glass, foam, rock, ceramics, films, polymer foams, substrates coated with inks, dyes, pigments, PVDC and the like or combinations thereof. Preferred substrates can also be selected from the group of biodegradable films, such as biodegradable films comprising natural or synthetic materials. Any of the above substrates, and/or the polymers of this invention, may be corona discharge treated, flame treated, electron beam irradiated, gamma irradiated, microwaved, plasma treated, or silanized.

The adhesive composition can be applied at a molten state onto the above said substrates by any application procedures, including but not limited to application with rollers, nozzles, spraying units, slot die and the like. The adhesives can be applied partially or fully onto one or multiple substrates to form a bond. The PSHMA is applied onto the substrate of the article at a molten state and the adhesive is cooled. The PSHMA can be attached and reattached onto a second substrate with pressure, and maintains tack and peel over prolonged time. Typical thickness of the PSHMA is applied from about 0.2 to about 5 mil thickness onto a substrate. Optionally, a liner or a second substrate is applied on top of the applied adhesive, or the adhesive is wound in a roll.

The adhesives of the invention balances tack and peel performances to be useful as PSHMA. In one embodiment, the adhesives have (i) a heat of fusion less than 1.5 J/g, measured at 1° C./min heating and cooling rate in accordance with ASTM D3418-2, (ii) a peak glass transition temperature from −40 to 5° C., and (iii) storage modulus (G′) at 25° C., of less than 5×10⁴ Pascal. The adhesives further have a peel force on of at least 150 gf/in on a cotton fabric substrate in accordance with cotton peel method at 25 gsm add-on level, and maintain this strength even after aging for 10 weeks at 40° C. In other embodiment, the adhesives have a peel force of at least 5 lb/in (80 oz/in) on a stainless steel testing panel, in accordance with PSTC-101 at 25 gsm add-on level; and maintain this peel strength even after aging for 16 weeks at ambient.

### EXAMPLES

Heat of fusion was measured by at a rate of 10° C./min for polymer, and 1° C./min for adhesive, heating and cooling in accordance with ASTM D3418-12.

The storage modulus (G′) at 20° C. was measured by rheology techniques on a Rheometric RDA-III Dynamic Analyzer. The Temperature-Step mode was used utilizing the 8 mm diameter parallel plate geometry. The sweep run was attained from about −50° C. to 150° C. at 5° C. per step with 10 seconds equilibration delay at each step. The oscillatory frequency was 10 radians/second with an autostrain function of 0.05 percent strain initially, increasing in positive 30% percent adjacent whenever the torque decreased to 200 gram-centimeters. The maximum strain was set at 30%. The plates were used with an initial gap of 2.5 mm. The sample was loaded at 90° C., and then cooled to −50° C., and the test started (the “hold”) function corrected for the thermal expansion or contraction of the test chamber is heated or cooled. The sample was maintained in a nitrogen environment throughout the measurement.

The peak tan delta (a representation of the glass transition temperature) was determined from the above rheology measurements, and specifically from the peak value from a plot of G″/G′ against temperature.

Tack or adhesion refers to the adhesive's ability to bond immediately to a surface. Tack was determined by loop tack measurement, method PSTC-16.

Peel value quantifies the strength of the adhesion of the adhesive to the substrates. Peel values of the adhesive was measured on stainless steel substrate and cotton substrates for both initial and aged samples. For peel values measured on stainless steel substrate, method PSTC-101 was followed. For peel values measured on cotton substrates, the cotton peel method was as follows:
1. The adhesive was applied molten via slot coating to a release liner and transfer coated to a polyethylene film.
2. The adhesive pattern was approximately 1.5 inches wide and a coat weight of 20 gsm.
3. A 4 inch long sample of coating was applied to a test cotton fabric where the adhesive is in contact with the cotton fabric.
4. A 250 g square weight was applied on top of the coating/fabric bond. The weighted sample was placed in a 40° C. oven for 1 hour.
5. When removed, the sample was equilibrated at room temperature for 30 minutes. The peel force was measured via Instron Sintech 1 D.
6. The test speed was 20 inches/min and the peel force was recorded in gf/inch.

Adhesive samples with various base polymers were made, in accordance with Table 1. The adhesives were formed by mixing the base polymer with a hydrocarbon tackifier (having a R&B softening point of about 100° C.) and a plasticizer (liquid at room temperature) at 150° C., until the adhesive became homogeneous. Table 1 also shows the content of the polymer, and the heat of fusion and peak Tg of the adhesive samples.

TABLE 1

| | | Polymer | ΔHf | Peak Tg |
|---|---|---|---|---|
| | Polymer | (%) | (J/g) | (° C.) |
| Comp Sample A | OBC/APAO | 11/10 | 1.023 | 10 |
| Comp Sample B | OBC (mPO) | 22 | 6.471 | −6 |
| Comp Sample C | APAO | 80 | N/A* | −5 |
| Comp Sample D | APAO | 40 | N/A* | −10 |
| Sample PSA-1 | mPO | 22 | 0.580 | 0 |
| Sample PSA-2** | mPO | 22 | 0.500 | 0 |
| Sample PSA-3 | mPO blend*** | 22 | 0.686 | −4 |

*Amorphous poly-α-olefin adhesive did not have a discernable ΔHf value.
**PSA-3 used different hydrocarbon tackifiers and plasticizers than PSA-1.
***A blend of metallocene catalyzed polyolefin that consisted of two different molecular weights (MFR 20 g/10 min and 8 g/10 min, ASTM D1238 at 230° C./2.16 kg) in a ratio of 3:1 was used.

Comparative Sample A was prepared in accordance with US 2011/0021103, example 17121-42-J-C. The polymer blend of OBC and APAO resulted in a peak Tg values too high to be useful as a PSA. Comparative Sample B, containing a metallocene catalyzed OBC polymer, resulted in heat of fusion too high to be useful as a PSA. Comparative Sample C, DISPOMELT® LITE 300 (APAO based) is a commercially available construction adhesive from Henkel. Comparative Sample C lost pressure sensitivity within three days of aging at 40° C. Comparative Sample D, also APAO based, lost pressure sensitivity upon aging.

Samples PSA-1 and PSA-2 resulted in acceptable PSA properties: heat of fusion less than 1.5 J/g and a peak Tg value of 0° C. Sample PSA-3 contains a mixture of metallocene-catalyzed polyolefin random copolymers having different Mw. Again, the adhesive made with the mixture of metallocene catalyzed polyolefin random copolymers had acceptable PSA properties: heat of fusion less than 1.5 J/g and a peak Tg value of −4° C.

Sample PSA-1 was formed with the components shown in Table 2.

TABLE 2

| Components to Sample PSA-1 | Wt % |
|---|---|
| Vistamaxx 6202 (ΔHf = 2.7 J/g) (metallocene catalyzed PP/PE | 22 |
| copolymer, ExxonMobil Chemical) | |
| Escorez 5400 (hydrogenated hydrocarbon resin with a 100° C. | 48 |
| Ring and Ball Softening Point, ExxonMobil Chemical) | |
| Indopol H1500 (polybutene with 2200 Mn, Ineos) | 15 |
| Krystol (white mineral oil, Petro-Canada) | 15 |

Sample PSA-1 had a heat of fusion value of 0.580 J/g, Tg peak value of 0° C., a storage modulus (G′) at 25° C. of 3×10⁴, and a loop tack value of 7.6 lbs.

Adhesion and peel strength at 180° were measured for Sample PSA-1 and Comparative Sample B on stainless steel substrates. The results for initial and aged (for 16 weeks at ambient temperature) are shown in Table 3.

TABLE 3

| | Initial peel strength | Aged peel strength |
|---|---|---|
| | (lbf/in) | (lbf/in) |
| Sample PSA-1 | 7.4 | 8.1 |
| Comp Sample B | 5.8 | 4.5 |

Sample PSA-1 exhibited excellent initial peel strength to stainless steel substrate, and maintained this performance even after 16 weeks of aging. In contrast, the peel strength of Comparative Sample B had lower initial peel strength value and this decreased over time.

Adhesion and peel strength at 40° C. were measured for Sample PSA-2 and Comparative Sample D on cotton substrates. The results for initial and aged (for 10 weeks at 40° C.) are shown in Table 4.

TABLE 4

| | Initial peel strength | Aged peel strength |
|---|---|---|
| | (gf/in) | (gf/in) |
| Sample PSA-2 | 160 | 125 |
| Comp Sample D | 69 | too low to measure |

Sample PSA-2 exhibited excellent cotton peel performance and had minimal change in performance even after aging 10 weeks at 40° C. Comparative Sample D, APAO-based, had significantly lower initial peel strength than Sample PSA-3, and this value decreased over time, and became immeasurable after 10 weeks. While not bound to any specific theory, it is believed that the APAO base polymer increased crystallization over time, and thus, the tack and peel performances decreased.

Many modifications and variations of this invention can be made without departing from its spirit and scope, as will be apparent to those skilled in the art. The specific embodiments described herein are offered by way of example only, and the invention is to be limited only by the terms of the appended claims, along with the full scope of equivalents to which such claims are entitled.

I/we claim:

1. A hot melt pressure sensitive adhesive comprising greater than about 15 wt %, based on the total weight of the adhesive, of a metallocene-catalyzed polyolefin random copolymer;
wherein the adhesive has (i) a heat of fusion less than 1.5 J/g, measured at 1° C./min heating and cooling rate in accordance with ASTM D3418-12; and (ii) a peak glass transition temperature (Tg) from −40° C. to 5° C.

2. The hot melt pressure sensitive adhesive of claim 1, wherein the copolymer has a weight average molecular weight of greater than 100,000.

3. The hot melt pressure sensitive adhesive of claim 1, wherein the copolymer has a heat of fusion less than 15 J/g measured at 10° C./min heating and a cooling rate in accordance with ASTM D3418-12.

4. The hot melt pressure sensitive adhesive of claim 3, wherein the adhesive is substantially free of any other polymers than the metallocene-catalyzed polyolefin random copolymer that has a heat of fusion less than 15 J/g.

5. The hot melt pressure sensitive adhesive of claim 1, wherein the copolymer is selected from the group consisting of C2, C3, C4, C5, C6, C7, C8, C9, C10, C11 and C12 monomers.

6. The hot melt pressure sensitive adhesive of claim 5, wherein the copolymer comprises propylene and ethylene monomers.

7. The hot melt pressure sensitive adhesive of claim 1, further comprising a tackifier.

8. The hot melt pressure sensitive adhesive of claim 7, wherein the tackifier is selected from the group consisting of C5 resins, petroleum distillates, hydrogenated hydrocarbons, C5 resins, C9 resins, polyterpenes, rosins, hydrogenated rosins, rosin esters and mixtures thereof.

9. A hot melt pressure sensitive adhesive comprising:
i. about 10 to about 40 wt % of a metallocene-catalyzed polyolefin random copolymer, which has a heat of fusion less than about 15 J/g measured at 10° C/min heating and cooling rate in accordance with ASTM D3418-12;
ii. about 40 to about 85 wt % of a tackifier; and
iii. about 1 to about 50 wt % of a plasticizer;
iv. optionally, an additives; and
wherein the total wt % adds to 100%;
wherein the adhesive has (a) a heat of fusion less than 1.5 J/g, measured at 1° C./min heating and cooling rate in accordance with ASTM D3418-12;
(b) a peak glass transition temperature from −40° C. to 5° C., and (c) a storage modulus, at 25° C., of less than 5×10⁴ Pascal.

10. The hot melt pressure sensitive adhesive of claim of claim 9, wherein the copolymer is selected from the group consisting of C2, C3, C4, C5, C6, C7, C8, C9, C10, C11 and C12 monomers.

11. The hot melt pressure sensitive adhesive of claim 9, wherein the tackifier is selected from the group consisting of C5 resins, petroleum distillates, hydrogenated hydrocarbons, C5 resins, C9 resins, polyterpenes, rosins, hydrogenated rosins, rosin esters and mixtures thereof.

12. The hot melt pressure sensitive adhesive of claim 9 comprising up to 30 wt % of an additive, wherein the additive is an anti-oxidant, colorant, filler, and mixtures thereof.

13. An article comprising the adhesive of claim 1.

14. The article of claim 13 which is a film, label, packing slip, pouch, security bag, tape, graphic, personal care product, feminine care product or positioning article.

15. An article comprising the adhesive of claim 9.

16. The article of claim 15 which is a film, label, packing slip, pouch, security bag, tape, graphic, personal care product, feminine care product, positioning article.

17. A hot melt pressure sensitive adhesive comprising greater than 15 wt %, based on the total weight of the adhesive, of a metallocene-catalyzed polyolefin random copolymer;
wherein the adhesive has (i) a heat of fusion less than 1.5 J/g measured at 1° C./min heating and cooling rate in accordance with ASTM D3418-12; (ii) a peak glass transition temperature from −40° C. to 5° C.; (iii) a peel force of at least 150 gf/in on a cotton fabric substrate in accordance with cotton peel method at 25 gsm add-on level; and (iv) an aged peel force after 10 weeks at 40° C. of at least 100 gf/in on a cotton fabric substrate in accordance with cotton peel method at 25 gsm add-on level.

18. The hot melt pressure sensitive adhesive of claim 17, wherein the adhesive has (v) a peel force on of at least 5 lb/in on a stainless steel testing panel, in accordance with PSTC-101 at 25 gsm add-on level; and (vi) an aged peel force after 16 weeks at ambient temperature of at least 5 lb/in on a stainless steel testing panel, in accordance with PSTC-101 at 25 gsm add-on level.

19. An article comprising the adhesive of claim 17.

20. The article of claim 19 which is a film, label, packing slip, pouch, security bag, tape, graphic, personal care product, feminine care product or positioning article.
